(19) United States
(12) Patent Application Publication
(10) Pub. No.: US 2025/0270009 A1
(43) Pub. Date: Aug. 28, 2025

(54) water feeder stopper for preventing inverted water leakage

(71) Applicant: NETVUE TECHNOLOGIES CO., LTD., Nanshan District (CN)

(72) Inventors: Youle Hu, Nanshan District (CN); Rui Zhang, Nanshan District (CN); Qiang Feng, Nanshan District (CN)

(21) Appl. No.: 18/900,425

(22) Filed: Sep. 27, 2024

(30) Foreign Application Priority Data
Feb. 28, 2024 (CN) 202420375184.9

(51) Int. Cl. B65D 47/40

(52) U.S. Cl. CPC B65D 47/40

(57) ABSTRACT

The present invention relates to a water feeder stopper for preventing inverted water leakage, comprising a cover portion, an extension portion, and an opening and closing portion. The cover portion is a solid body connected to the extension portion, which is a hollow body. The opening and closing portion is provided in the middle of the cover portion and remains closed without external force. The extension portion is configured to form a tight seal with an inner side wall of a water storage bottle. The invention ensures no water leakage when the water storage bottle is inverted and inserted into a feeding tray, simplifying the installation process and providing good sealing performance.

### CROSS-REFERENCE TO RELATED APPLICATIONS

The application claims priority of Chinese patent application CN 2024203751849, filed on Feb. 28, 2024, which is incorporated herein by reference in its entireties.

### TECHNICAL FIELD

The present invention relates to the field of water feeders, in particular to a water feeder stopper for preventing inverted water leakage.

### BACKGROUND

The hummingbird water feeder usually has a water storage bottle, located above the feeding tray, to continuously supply sugar water to the feeding tray. However, for the existing water storage bottle, if the bottle mouth is downward and the upper part is sealed, if the water storage bottle needs to be filled with water, the feeding tray can only be placed upside down and rotatably mounted on the water storage bottle, and then the water storage bottle is integrally placed upright, and the installation steps after the water storage bottle is filled with water are tedious, and water leakage may occur.

Therefore, we need to develop a water feeder stopper for preventing inverted water leakage, which uses a flexible material and has strong sealing performance, and can be directly inserted into the feeding tray by inverting the water storage bottle, so that the installation is simple and universal.

### SUMMARY

The present invention aims to provide a water feeder stopper for preventing inverted water leakage, so as to solve the problems of troublesome installation, easy water leakage and the like of the existing honeycomb bird feeding water storage bottle mentioned in the above background art.

To realize the above purposes, the present invention adopts the following technical scheme: A water feeder stopper for preventing inverted water leakage, comprising:
a cover portion, wherein the cover portion is a solid body, a lower end of the cover portion is connected to an extension portion, the extension portion is a hollow body, an opening and closing portion is provided in the middle of the cover portion, and the opening and closing portion remains in a closed state without an external force;
the extension portion is used to be tightly attached to an inner side wall of a water storage bottle.

Further, the opening and closing portion is provided with a penetrating incision

Further, the incision is at least one.

Further, an outer diameter of the cover portion is greater than an outer diameter of the extension portion.

Further, a middle portion of the cover portion is concave inward.

Further, a groove pattern is provided on an outer side wall of the extension portion.

Further, the groove pattern is at least one.

Further, a center point of the opening and closing portion is located at a center point of the cover portion, and a center point of the penetrating incision is located at the center point of the opening and closing portion.

Further, the opening and closing portion is made of a flexible material.

It can be seen from the above technical scheme that, compared with the prior art, the present invention has at least the following advantages and positive effects:

By designing the hummingbird water feeder stopper for preventing inverted water leakage, the inverted movement before the water storage bottle is inserted into the feeder and the water leakage prevention when the water storage bottle is inserted into the feeder can be achieved; and by arranging the incision in the opening and closing portion of the bottle stopper, the water storage bottle of the hummingbird feeder can be directly inserted into the feeding tray when being inverted, so that the sugar water in the water storage bottle flows into the feeding tray, the water storage bottle is simple to install, and has good sealing performance.

### BRIEF DESCRIPTION OF THE DRAWINGS

In order to more clearly illustrate the specific embodiments of the present disclosure or the technical solutions in the prior art, the following briefly describes the accompanying drawings that need to be used in the description of the specific embodiments or the prior art. In all the drawings, similar elements or sections are generally identified by like reference numerals. In the drawings, elements or parts are not necessarily drawn to actual scale.

FIG. 1 shows a structural diagram of a water feeder stopper for preventing inverted water leakage according to the embodiment;

FIG. 2 shows a cross-sectional view of a water feeder stopper for preventing inverted water leakage according to the embodiment;

FIG. 3 shows a schematic cross-sectional view of a connection between the hummingbird water feeder stopper and water storage bottle according to the embodiment;

FIG. 4 shows a schematic cross-sectional view of the connection of bottle stopper, water storage bottle and feeding tray of the hummingbird water feeder according to the embodiment;

wherein, 1. cover portion; 2. extension portion; 3. opening and closing portion; 4. groove pattern; 5. incision; 6. water storage bottle; 7. feeding tray; 8. piercing part.

### EMBODIMENTS

In order to explain the objectives, technical solutions, and advantages of the present disclosure more clearly, the technical solutions in the embodiments of the present disclosure will be clearly and completely described below with reference to the accompanying drawings in the embodiments of the present disclosure; rather, these embodiments are provided so that this disclosure will be more comprehensive and complete, and will fully convey the concepts of the exemplary embodiments to those skilled in the art.

Furthermore, the described features, structures, or characteristics may be combined in any suitable manner in one or more embodiments. In the following description, numerous specific details are provided to provide a thorough understanding of the embodiments of the present disclosure. However, those skilled in the art will appreciate that the technical solutions of the present disclosure may be practiced without one or more of the specific details, or other methods, components, apparatuses, steps, and the like may be used. In other instances, well-known methods, apparatuses, implementations, or operations are not shown or described in detail to avoid obscuring aspects of the present invention.

The block diagrams shown in the accompanying drawings are merely functional entities and do not necessarily correspond to physically independent entities. That is, these functional entities may be implemented in the form of software, or implemented in one or more hardware modules or integrated circuits, or implemented in different networks and/or processor devices and/or microcontroller devices.

The flowcharts shown in the accompanying drawings are merely exemplary descriptions, do not necessarily include all content and operations/steps, and are not necessarily performed in the described order. For example, some operations/steps may also be decomposed, and the operations/steps may be combined or partially combined, so the actual execution order may be changed according to actual situations.

The present invention is described in detail below with reference to specific embodiments:

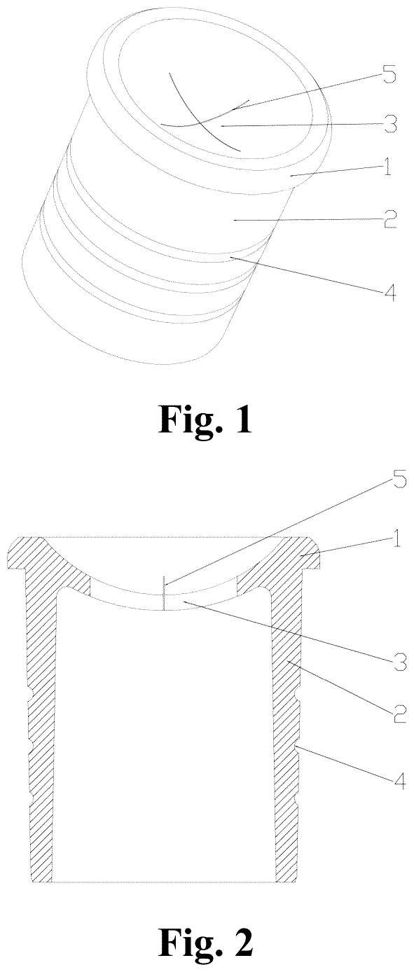

As shown in FIG. 1, which is a structural diagram of a water feeder stopper for preventing inverted water leakage according to the embodiment of the present disclosure, the structure is specifically applied to a water storage bottle of a hummingbird water feeder, which is specifically as follows:
a cover portion 1, wherein the cover portion 1 is a solid body, a lower end of the cover portion 1 is connected to an extension portion 2, the extension portion 2 is a hollow body, an opening and closing portion 3 is provided in the middle of the cover portion 1, and the opening and closing portion 3 remains in a closed state without an external force;
the extension portion 2 is used to be tightly attached to an inner side wall of a water storage bottle 6.

Preferably, in this embodiment, the bottle stopper is made of a flexible material, specifically silica gel, and the silica gel has high temperature resistance, corrosion resistance, aging resistance and biocompatibility, has good sealing performance, and can also be synthetic rubber, natural rubber, silica gel, etc., specifically such as styrene butadiene rubber, chloroprene rubber, ethylene propylene rubber, etc.

Preferably, the opening and closing portion 3 is provided with a penetrating incision 5.

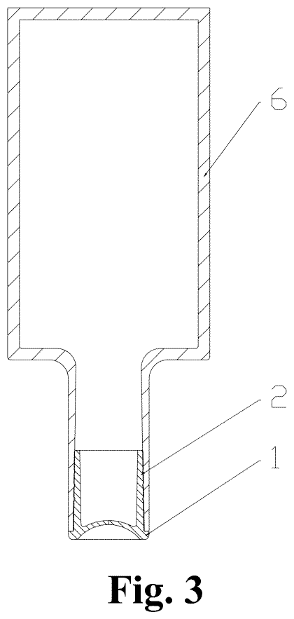

Specifically, in this embodiment, as shown in FIG. 1 as a cross-shaped incision 5, the incision 5 is very thin, although the wall thickness of the whole cover portion 1 is penetrated, the sealing performance at the incision 5 is not affected when the incision 5 is not pierced by the component, and after the bottle stopper is installed on the water storage bottle 6, the water storage bottle 6 is inverted, as shown in FIG. 3, due to the sealing performance of the bottle stopper, water does not flow out.

Specifically, the incision 5 can adjust the number, size and shape according to actual needs under the condition of combining the sealing performance of the material, for example, the cross-shaped incision 5 can be changed into a linear incision 5, or a rice-shaped incision 5 or a snowflake-shaped incision 5. As long as the sealing effect is not affected, it should be within the scope of the present application.

Preferably, in the radial direction, the extension portion 2 is located inside the cover portion 1.

Specifically, the outer diameter of the cover portion 1 is larger than the outer diameter of the bottle opening of the water storage bottle 6, and is used for covering the bottle opening and sealing the sugar water in the water storage bottle 6; the outer diameter of the extension portion 2 is smaller than the inner diameter of the bottle opening of the water storage bottle 6, and is naturally smaller than the outer diameter of the cover portion 1; as shown in FIG. 3, one side of the cover portion 1 is in close contact with the bottle opening of the water storage bottle 6, and the outer side wall of the extension portion 2 is tightly attached to the inner side wall of the bottle opening part of the water storage bottle 6. It should be noted that, if the bottle opening of the water storage bottle 6 is square or other shapes, the extension portion 2 and the cover portion 1 may also be adjusted accordingly, and are not limited to the cylindrical shape, the edge size and the edge shape of the cover portion 1, and the length of the extension portion 2, and the thickness of each part may also be correspondingly adjusted, so as to adjust the sealing performance of the bottle stopper on the bottle opening of the water storage bottle 6.

Preferably, the middle part of the front surface of the cover portion 1 is concave inwards.

Specifically, as shown in the cross-sectional view of FIG. 2, it can be seen that the middle part of the cover portion 1 is concave in the direction of the extension portion 2 to present a certain radian, the water pressure is borne when the inverted water storage bottle 6 filled with water is sealed, and the wall thickness of the opening and closing portion 3 in the middle of the cover portion 1 is smaller than that of other portions of the cover portion, so that the piercing part 8 can easily pierce the incision 5, and let the cover portion 1 release the seal. It should be noted that, the radian may be adjusted as required according to the sealing performance of the bottle stopper and the rigidity of the piercing part 8 on the feeding tray 7, and if the material used by the bottle stopper is not made into the radian of the concave, it can be realized that the incision 5 can be sealed when the incision 5 is not pierced, and does not seal during piercing, and can automatically restore the seal after the piercing is finished, then the radian may not be used, or the radian may be reduced.

Preferably, the outer side wall of the extension portion 2 is provided with a groove pattern 4.

Specifically, as shown in FIG. 2, in this embodiment, the groove pattern 4 is a semi-circular ring-shaped structure concave inward on the outer side wall of the extension portion 2, and FIG. 2 shows three groove patterns for increasing the friction and sealing between the bottle mouth of the water storage bottle 6 and the outer side wall of the extension portion 2 of the bird feeder, and the groove pattern 4 is provided with at least one, which can be designed and adjusted according to the length of the extension portion and the size and shape of the required groove pattern, and is not limited to the ring shape.

Specifically, the inner side of the bottle opening of the water bottle 6 in FIG. 3 is provided with a raised pattern which is just engaged with the groove pattern 4, and if the bottle opening needs to be sealed, the groove pattern 4 and the raised pattern can be designed to be closely matched in size, so as to increase the fastening performance of the bottle stopper on the bottle opening.

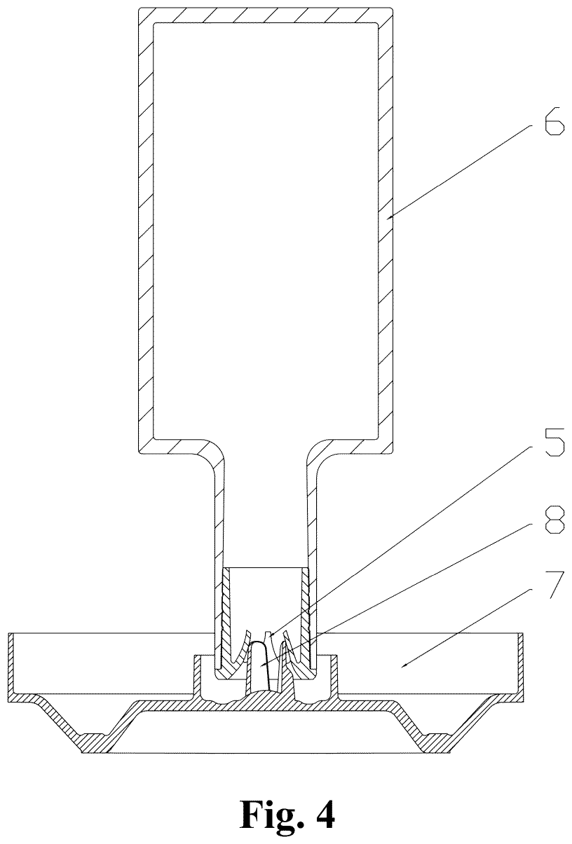

Preferably, the center point of the opening and closing portion 3 is located at the center point of the cover portion 1, and the center point of the penetrating incision 5 is located at the center point of the opening and closing portion 3; When the water storage bottle of hummingbird water feeder is put on a bottle stopper, and communicate with the feeding tray 7, as shown in FIG. 4, the center of the incision 5 of the opening and closing portion 3 is jacked by the piercing part 8 of the feeding tray 7, and at this time, the sugar water in the water storage bottle can flow into the feeding tray 7, so that the inverted water storage bottle shown in FIG. 3 does not leak water, the inverted water storage bottle can be directly inserted into the feeding tray 7, the water storage bottle is not leaked during insertion, and the water storage bottle is simple and efficient to install; and after the insertion, the water leakage prevention after the installation and communication can be achieved in combination with other structures in the feeding tray 7.

Specifically, as shown in FIG. 4, when the water storage bottle 6, the bottle stopper and the feeding tray 7 of the bird feeder are communicated, the piercing part 8 in the feeding tray 7 pierces the center point of the incision 5 in the center of the opening and closing portion 3 at the center of the cover portion 1, and the reverse side of the cover portion 1 is closely attached to the edge of the bottle opening of the water storage bottle 6 of the hummingbird water feeder; and if the tightness of the connection between the bottle stopper and the water storage bottle 6 is to be adjusted, the groove pattern 4 can be misaligned, the raised pattern is not aligned, and the misalignment means that when the bottle stopper pulls out a section, the inner surface of the cap portion 1 no longer fits the edge of the mouth of the water storage bottle 6, or increase or decrease the length of the extension portion 2; if it is necessary to adjust the piercing difficulty of the opening and closing portion 3 and the piercing part 8, it can be achieved by changing the rigidity of piercing part 8, the thickness of opening and closing portion 3 and the shape and size of the incision 5.

In this embodiment, by designing the hummingbird water feeder stopper for preventing inverted water leakage, no water leakage can be realized when the water storage bottle 6 is reversely inserted into or not inserted into the feeding tray 7; by providing the incision 5 in the opening and closing portion of the bottle stopper, the bottle stopper can not be opened without external force, when something opens the incision 5 of the rubber stopper mouth, the silicone stopper does not seal the water storage bottle 6, so that the water in the water storage bottle 6 can flow out; when the water storage bottle 6 is sealed with a bottle stopper, the water storage bottle 6 of the hummingbird water feeder can be directly inserted into the feeding tray 7 when it is upside down, and the incision 5 is jacked by the piercing part 8 in the feeding tray 7, and the sugar water in the water storage bottle 6 flows into the feeding tray 7, so that the water storage bottle 6 does not need to be inverted after installation, and it simplifies the installation process, and has good sealing to prevent water leakage and dirt on the floor.

After considering the specification and practicing the present invention disclosed herein, the person skilled in the field will easily think of other implementation schemes of the present invention. The application is intended to cover any variation, use or adaptive change of the present invention that follows the general principle of the present invention and includes the common knowledge or customary technical means in the technical field not disclosed by the present invention. The description and embodiments are considered illustrative only, and the true scope and spirit of the present invention are indicated by the claims. It should be understood that the present invention is not limited to the exact structure already described above and shown in the drawings, and may be subject to various modifications and alterations without departing from its scope. The scope of the present invention is limited only by the attached claims.

What is claimed is:

1. A water feeder stopper for inverted water leakage, comprising:
a cover portion (1), wherein the cover portion (1) is a solid body, a lower end of the cover portion (1) is connected to an extension portion (2), the extension portion (2) is a hollow body, an opening and closing portion (3) is provided in the middle of the cover portion (1), and the opening and closing portion (3) remains in a closed state without an external force;
a middle portion of the cover portion (1) is concave inward; the extension portion (2) is configured to form a tight seal with an inner side wall of a water storage bottle (6), preventing fluid leakage; at least one groove pattern is provided on an outer side wall of the extension portion (2).

2. The water feeder stopper for preventing inverted water leakage according to claim 1, wherein the opening and closing portion (3) is provided with at least one penetrating incision (5).

3. (canceled)

4. The water feeder stopper for preventing inverted water leakage according to claim 2, wherein an outer diameter of the cover portion (1) is greater than an outer diameter of the extension portion (2).

5. (canceled)

6. (canceled)

7. (canceled)

8. The water feeder stopper for preventing inverted water leakage according to claim 2, wherein a center point of the opening and closing portion (3) is located at a center point of the cover portion (1), and a center point of the penetrating incision is located at the center point of the opening and closing portion (3).

9. The water feeder stopper for preventing inverted water leakage according to claim 1, wherein the opening and closing portion (3) is made of a flexible material, including but not limited to silica gel, synthetic rubber, and natural rubber.
